(19) United States
(12) Patent Application Publication
(10) Pub. No.: US 2025/0222354 A1
(43) Pub. Date: Jul. 10, 2025

(54) ADJUSTMENT OF PERCEIVED MAP LOCATION

(71) Applicant: Tencent America LLC, Palo Alto, CA (US)

(72) Inventors: Stefan Haines, Palo Alto, CA (US); Christopher Allsopp, Palo Alto, CA (US); Benjamin Bickle, Palo Alto, CA (US); Gavin Newton Glenn McDowell, Palo Alto, CA (US)

(73) Assignee: Tencent America LLC, Palo Alto, CA (US)

(21) Appl. No.: 18/404,880

(22) Filed: Jan. 4, 2024

(51) Int. Cl. A63F 13/5372; A63F 13/5258; A63F 13/5378

(52) U.S. Cl. CPC A63F 13/5372; A63F 13/5258; A63F 13/5378

(57) ABSTRACT

A method is provided for adjusting a perceived map location of a first player in a video game. The method includes determining whether the perceived map location of a virtual game asset of a first player of the game starting from a first location on a map of a virtual environment is to be displayed as starting from a second location on the map, the first location is symmetrical from the second location about a reference point on the map. The method includes, based on a determination that the perceived map location is to be displayed as starting from the second location, adjusting a location of the virtual game asset on the map to an adjusted location for display on a device displayed map according to the second location. The method further includes displaying the virtual game asset of the first player at the adjusted location on the device displayed map.

### TECHNICAL FIELD

The present disclosure relates to adjusting a map location of a player in a game.

### BACKGROUND

A video game is an electronic or digital game that involves human interaction with a user interface to generate visual and/or auditory feedback on a computing device. Video games can be played on various computing devices, including consoles, personal computers, and mobile devices, such as smartphones and tablets.

A player versus player (PvP) game is a specific type of video game in which players can compete against each other. PvP games may include competitive games, such as real-time strategy (RTS) games, first person shooter (FPS) games, or multiplayer online battle arenas (MOBAs).

In PVP games, a map can serve as a virtual environment in which the players play against one another. The players are assigned different starting locations on the map. In order to promote balanced gameplay, developers may design these gameplay maps to provide a more balanced and engaging environment for multiplayer gameplay. The maps can feature strategically placed obstacles, cover, terrain, spawn points, and/or item locations to provide a fair competition. However, there may be inherent advantages associated with the initial locations of players.

Thus, it may be beneficial to eliminate any inherent advantages of starting locations of the player, for example player starting locations in a symmetrical game map in a video game.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

The present disclosure includes a method and an apparatus of adjusting a perceived map location of a first player in a game such that a plurality of players appear to be playing from a same location of a game map from their own perspective. In an example, the players also view certain virtual objects of the game map (such as trees, mountains, etc.) in the game from a same direction.

An aspect of this subject matter described is implemented in a method of adjusting a perceived map location in a game. The method includes determining whether the perceived map location of a virtual game asset of a first player of the game starting from a first location on a map of a virtual environment is to be displayed as starting from a second location on the map of the virtual environment. The first location and the second location are symmetrical about a reference point on the map of the virtual environment. The method also includes, based on a determination that the perceived map location is to be displayed as starting from the second location, adjusting a location of the virtual game asset of the first player on the map to an adjusted location for display on a device displayed map according to the second location. The method further includes displaying the virtual game asset of the first player at the adjusted location on the device displayed map. The adjusted location being different from an actual location of the virtual game asset in the virtual environment.

An aspect of this subject matter described is implemented in a method of adjusting a perceived map location in a game. The method includes receiving data comprising at least actual location information for a virtual game asset of a first player starting from a first location on a map of a virtual environment. The perceived map location of the virtual game asset of the first player being adjusted to a second location on the map of the virtual environment. The first location and the second location being symmetrical about a reference point on the map of the virtual environment. The method also includes adjusting a location of the virtual game asset that is indicated by the actual location information to an adjusted location based on the reference point. The method further includes outputting the adjusted location of the virtual game asset. The adjusted location is different from the location indicated by the actual location information for the virtual game asset of the first player on the map in the virtual environment.

A further aspect of the subject matter described in this disclosure can be implemented in an apparatus for adjusting a perceived map location in a game. The apparatus includes processing circuitry configured to determine whether the perceived map location of a virtual game asset of a first player of the game starting from a first location on a map of a virtual environment is to be displayed as starting from a second location on the map of the virtual environment. The first location and the second location are symmetrical about a reference point on the map of the virtual environment. The processing circuitry is configured to, based on a determination that the perceived map location is to be displayed as starting from the second location, adjust a location of the virtual game asset of the first player on the map to an adjusted location for display on a device displayed map according to the second location. Further, the processing circuitry is configured to display the virtual game asset of the first player at the adjusted location on the device displayed map. The adjusted location being different from an actual location of the virtual game asset on the map in the virtual environment.

A further aspect of the subject matter described in this disclosure can be implemented in an apparatus for adjusting a perceived map location in a game. The apparatus includes processing circuitry configured to receive data comprising at least actual location information for a virtual game asset of a first player starting from a first location on a map of a virtual environment. The perceived map location of the virtual game asset of the first player is adjusted to a second location on the map of the virtual environment. The first location and the second location are symmetrical about a reference point on the map of the virtual environment. The processing circuitry is also configured to adjust a location of the virtual game asset that is indicated by the actual location information to an adjusted location based on the reference point. The processing circuitry is further configured to output the adjusted location of the virtual game asset. The adjusted location being different from the location indicated by the actual location information for the virtual game asset of the first player on the map in the virtual environment.

Yet another aspect of the subject matter described in this disclosure can be implemented in a non-transitory computer-readable storage medium storing computer-readable instructions thereon, which, when executed by processing circuitry, cause the processing circuitry to perform a method for adjusting a perceived map location in a game. The method includes determining whether the perceived map location of a virtual game asset of a first player of the game starting from a first location on a map of a virtual environment is to be displayed as starting from a second location on the map of the virtual environment. The first location and the second location are symmetrical about a reference point on the map of the virtual environment. The method also includes, based on a determination that the perceived map location is to be displayed as starting from the second location, adjusting a location of the virtual game asset of the first player on the map to an adjusted location for display on a device displayed map according to the second location. The method further includes displaying the virtual game asset of the first player at the adjusted location on the device displayed map. The adjusted location being different from an actual location of the virtual game asset on the map in the virtual environment.

Yet another aspect of the subject matter described in this disclosure can be implemented in a non-transitory computer-readable storage medium storing computer-readable instructions thereon, which, when executed by processing circuitry, cause the processing circuitry to perform a method for adjusting a perceived map location in a game. The method includes receiving data comprising at least actual location information for a virtual game asset of a first player starting from a first location on a map of a virtual environment. The perceived map location of the virtual game asset of a first player being adjusted to a second location on the map of the virtual environment. The first location and the second location being symmetrical about a reference point on the map of the virtual environment. The method also includes adjusting a location of the virtual game asset that is indicated by the actual location information to an adjusted location based on the reference point. The method further includes outputting the adjusted location of the virtual game asset. The adjusted location being different from the location indicated by the actual location information for the virtual game asset of the first player on the map in the virtual environment.

To accomplish the foregoing and related ends, the one or more aspects include the features hereinafter described and particularly pointed out in the claims. The following description and the annexed drawings set forth in detail certain illustrative features of the one or more aspects. These features are indicative, however, of but a few of the various ways in which the principles of various aspects may be employed, and this description is not intended to describe all such aspects and their equivalents.

### BRIEF DESCRIPTION OF DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 is a block diagram of an exemplary computing device.

FIGS. 2A-2B are diagrams of exemplary symmetrical game maps according to aspects of the present disclosure.

FIG. 3 is a diagram of another exemplary symmetrical game map according to aspects of the present disclosure.

FIGS. 4A-4B are schematic diagrams showing a comparison of adjusting a unit layer, adjusting a map layer, and how a virtual scene may be rendered if no adjustment is performed.

FIG. 5 is a schematic diagram of a game architecture according to some aspects of the present disclosure.

FIGS. 6A-6C illustrate schematic diagrams of adjusting a unit layer on a fixed map layer according to some aspects of the present disclosure.

FIG. 7 illustrates a flowchart of a method of adjusting a map location of a first player in a game in accordance with one or more techniques of this disclosure.

FIG. 8 illustrates a flowchart of a method of adjusting a map location of a first player in a game in accordance with one or more techniques of this disclosure.

Like reference numbers and designations in the various drawings indicate like elements.

### DETAILED DESCRIPTION

The following description is directed to some exemplary aspects for the purposes of describing innovative aspects of this disclosure. However, a person having ordinary skill in the art will readily recognize that the teachings herein can be applied in a multitude of different ways.

Users, or players, may face each other in a competitive player versus player (PvP) type game, for example in a video game (e.g., a computer game). In PvP type games, each user plays on a same map and begins a match at different starting locations (e.g., opposite locations), or initial locations, of a map. The starting location corresponds to a main base location of a user, for example. A “perspective” of what direction the user is playing in during the game is based on the starting location.

A simple, yet effective way to make a balanced game map for a competitive game is to make it symmetrical. As an example, a non-symmetrical map may provide a user that begins the game at a particular starting location an advantage because that user may traverse the map quicker or be closer to more resources at their starting location as compared to their opponent. Therefore, to avoid such advantages, a map may be designed to be as symmetrical as possible such that no users have an advantage in their initial starting location of the game.

To avoid unfair advantages, game designers may design the map to be symmetrical such that the starting locations are balanced in order to promote fair gameplay for all users. However, there may be slight advantages to starting at a particular location of the map that cannot be avoided.

For example, it may be advantageous to have a starting location at a bottom left corner of the map (e.g., player 1 side) and have their opponent begin on a top right corner of the map (e.g., player 2 side) such that the flow of movement for the match goes from left to right. As another example in a side-scrolling fighting game, it may be advantageous to begin the game on the left side (e.g., player 1 side) as opposed to being on the right side (e.g., player 2 side).

Data has shown that users who see their actions coming from bottom left to top right (e.g., player 1 side) to face their opponents have an advantage. This advantage could be due to various factors such as the placement of user interface (UI) elements (e.g., at a bottom of the screen), a western-influence of reading from left to right, or a majority of users being right handed. In addition, another advantage could be that the game map was inherently designed starting from a player 1 side of bottom left to top right side and then simply mirrored to create symmetry in the map. Therefore, matches in a top-down type game may have an outcome decided in small part by what direction the flow of movement for the match is due to a starting location of a user. This may create a statistically “advantageous” side of a map to be assigned to when playing, which cannot be avoided in PVP games since users cannot begin at the same location of a map.

In some examples, a first user may begin the game at a bottom left side of the map (e.g., player 1 side) and a second user may begin the game at a top right side of the map (e.g., player 2 side). The first user plays from the bottom left location and the second user plays from the top right location. Accordingly, the game flow for first user will generally be moving units from bottom left to top right whereas the second user will generally be moving units from top right to bottom left. In some cases, a first user who is moving from left to right may have an advantage over a second user who is moving from right to left due to factors such as the layout or position of a UI, for example when the UI is positioned at the bottom of a display, or a western prevalence of reading from left to right. In other cases, it may simply be that a user has more experience playing from the bottom left side of the game map.

In addition, since each user is playing on a same map, it is not possible for each user to be assigned to a same starting location of the map. In some video games or sports, to alleviate any perceived imbalance between sides, users may alternate sides or roles because, theoretically, all users have equal opportunity to exploit (or suffer) any imbalance. This approach is common in sports, where teams may switch sides at half-time. However, in a single match of a game, users cannot practically switch sides mid-game so one approach to balance gameplay on a balanced map may be to randomly select where a user may begin in a particular location.

To address possible advantages of certain starting locations or bases on a game map, it would be advantageous to allow a plurality of users to play a game from a same location of the map. The same location of the map may correspond to any region of the map, such as a corner or a side of the map. In an example, the same location of the map is a bottom left region of the map.

Each of the plurality of users is assigned to a different actual starting location on a game map. The actual starting locations correspond to different locations on a ground truth map, for example. The ground truth map corresponds to an actual or “ground truth” state of the game environment.

In an aspect of the disclosure, an actual map location of each game asset, of at least one of the plurality of users, is adjusted such that a perceived map location of each of the plurality of users corresponds to a same location of the map. For example, locations of game assets of a user are adjusted from actual map locations, or ground truth map locations, to perceived map locations. Game assets include buildings and units, for example. The ground truth map location corresponds to the actual coordinates or “ground truth” coordinate of a respective game asset in the map.

In an aspect, a plurality of users are provided with a same perceived map location, regardless of the actual locations of game assets of the respective users on the map. When the plurality of users includes two user, this may allow both users to play a game from a same perceived map location, for example, by engaging in a same game flow of moving from left to right to face their opponents.

Additionally, in 3-D games, art in the virtual environment may need to be modeled from various angles, and in some cases every angle, based on which directions game elements may be viewed. When POVs of users differ based on the starting map locations of the user, the virtual environment may need to be modeled to account for the different viewing directions of the POVs. For example, a statute in the virtual environment will need to be modeled from a plurality of sides since different users may approach the same statue from different directions and/or angles.

Aspects of the present disclosure include a method of adjusting a perceived map location of a first user in a game with a symmetrical map. The adjustment of the perceived map location of the first user may be performed by adjusting (e.g., rotating or flipping) locations of game assets in the game. This may be able to help eliminate any positional advantage by providing each user a same perceived starting map location regardless of the actual location of the user on the map and what directional flow the user is playing in. For example, adjusting the map location of one of the users may allow both users to perceive their actions as coming from a “default” or “normal” game flow. In an example, the default game flow is from a bottom left to face an opponent at a top right.

The adjustment of the perceived map location for one of the users may be accomplished by adjusting locations of the game assets based on a reference point. The reference point may correspond to a point of symmetry or be included in a line of symmetry in some aspects. In an example, the locations are adjusted by converting the locations of the game assets, such as by changing sign values of actual map coordinates (e.g., x, y) of the game assets.

Actual map locations may only need to be adjusted for a subset of users. For example, the actual map locations may not need to be adjusted for a user that is assigned to a desired perceived map location or when a user does not wish to adjust their perceived map location.

In an aspect, the actual map location of one of the users corresponds to a desired perceived map location. Accordingly, locations of game assets displayed to the user assigned to the actual map location, corresponding to the desired perceived map location, need not be adjusted. However, for the subset of users assigned to an actual map location that is different from the desired perceived map location, aspects of the present disclosure include adjusting locations of game assets such that the subset of users are able to play the game from the same desired perceived map location.

In an example, a perceived map location of a first user is adjusted from an actual map location of the first user. Locations of a virtual unit (e.g., movable virtual unit) of the first user and a virtual unit of a second user on the map may be adjusted such that the first user and the second user have the same perceived map location. The locations of the virtual units may be adjusted while the game map stays fixed. Display of the perceived map location of the first user that is adjusted from the actual map location of the first user may be referred to as a flipped mode. Display of the perceived map location of the second user that is the same as the actual map location of the first user may be referred to as a normal mode.

Accordingly, during the game, one user may be playing in a flipped mode and the other user may be playing in a normal mode. The flipped mode may be an option provided to the user or performed in the background unbeknownst to the user. In an example, neither of the users may be aware of which mode they are playing in. Instead, to each user, it will seem as though the respective user is playing in a same first starting location (e.g., bottom left of the map) and their opponent is playing in a same second starting location (e.g., top right of the map). Thus, the gameplay, map location, and controls for the user playing in the flipped mode will appear as though that user is playing in the first starting location even though the user's is actual location is the second starting location.

The adjustment method may be applied to virtual game environments where the game map is symmetrical (e.g., has radial symmetry) along a reference point or symmetrical along an axis. The symmetrical game map may include fixed elements and/or regions, such as impassable regions (e.g., obstacles) that are positioned in the map symmetrically. In some aspects, movement of virtual units and commands for moving the virtual units may be sent by users through a data layer to a server or component that determines the final location of the object. In some examples, the system performs an adjustment in code by manipulating commands of both the user play in the flipped mode and a user playing in the normal mode. Actual, or ground truth (or true), positions may be transmitted to all users and location information of a user is adjusted, or otherwise converted, if the user plays the game in the flipped mode. Computing devices of users playing in the flipped mode may receive or adjust (e.g., flip or rotate) incoming command and location information based on the desired perceived map location.

A first benefit of the present disclosure is that any perceived bias or advantage in starting at a first starting location of a game map can be eliminated. In addition, game designers may take advantage of the symmetry of the game map by focusing their design and detail on a single angle, or a limited number of angles, (e.g., removing or omitting back faces which will never be seen by a camera) of artwork in the virtual environment because each user has a same map location and POV toward the virtual environment. For example, when a game has a camera angle (e.g., a virtual camera angle) with a fixed shooting angle, game designers may be able to optimize a virtual environment in a game map by deleting or omitting things on virtual objects that a user may never see because each user is playing from a same map location, direction, and/or POV of the virtual environment. As another example, designers may save time in creating in the artwork of the virtual environment by setting a direction of sun and shadows for the best visual effect. As yet another example, designers may design trees or foliage to only look good for a single side since users will never see a “back face” of the tree. This allows game designers to optimize game visuals from a single point of view. In addition, this may also help simplify the environmental art creation process for game designers by reducing the file size of game maps. In turn, reduced file sizes of game maps will reduce loading times of game maps and computing power needed to render the graphics during the game.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different system configurations, networks, interactive methods, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatuses and methods. These apparatuses and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing circuitry). One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media, such as at least one non-transitory computer-readable storage medium. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

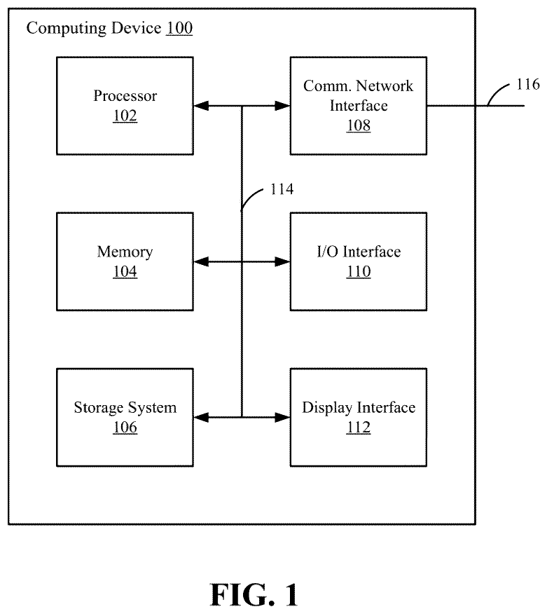

FIG. 1 is a block diagram of an exemplary computing device 100. A computing device 100 includes at least a processor 102, a memory system 104, a storage system 106, a communication network interface 108, an input/output (I/O) interface 110, and a display interface 112 communicatively coupled to a bus 114. The processor 102 is configured to execute executable instructions (e.g., programs). In some aspects, the processor 102 includes circuitry or any processor capable of processing the executable instructions.

As described herein, a device, such as the computing device 100, may refer to any user device, apparatus, or system configured to perform one or more techniques described herein. For example, a user device may be a client device, a computer (e.g., a personal computer (PC)), a desktop computer, a laptop computer, a tablet computer, a computer workstation, or a mainframe computer, a phone, a smart phone, a video game platform or console, a handheld device (e.g., a portable video game device or a personal digital assistant (PDA)), a wearable computing device (e.g., a smart watch), an augmented reality device, a virtual reality device, a display or display device, a television, a television set-top box, a network device, a digital media player, a video streaming device, a content streaming device, an in-car computer, or any other device configured to perform one or more techniques described herein. Processes herein may be described as performed by a particular component (e.g., a CPU), but, in further aspects, can be performed using other processing components configured to perform the described processes.

The computing device 100 may be any user device with a processor and memory. While many user devices on which to play video games are different, the user devices may share some common characteristics. For instance, the user devices may have some method of capturing user input such as a computer mouse, keyboard, remote control, touchscreen, game controller, or the like. In addition, the different user devices may also have some method of displaying a two-dimensional image using a display such as a TV screen or computer monitor (e.g., LED, LCD, or OLED) or touchscreen. In some devices, the user devices may have some method of displaying a three-dimensional image using a display such as a head-set display or augmented reality device. The user devices may have some form of processing CPU, although the capability often widely varies in terms of capability and performance. Further, in some aspects, the user devices may have a connection to the internet, such as an Ethernet connection, WiFi connection or mobile phone cell data connection.

In various aspects, one or more users may utilize their respective computing device to play one or more video games, including a computer game, mobile game, cloud game, or console game. The computing device 100 may display game assets on a game map. The game assets may include virtual units (e.g., movable units controllable by a user) and/or virtual objects (e.g., non-movable units such as virtual buildings controlled by a user. The game assets do not include non-playable elements or impassable areas such as trees, rivers, mountains, etc. The computing device 100 may further display one or more user interfaces (UIs) or visual displays associated with the game. The user interfaces may be configured to receive user selections (e.g., user input) for displaying visual menus, selecting virtual game assets (e.g., virtual units and/or virtual objects) for use in the game, or controlling the virtual game assets within an RTS game, for example. There may be any number of menus that provide opportunity for user selection via buttons, radio buttons, check boxes, sliders, text fields, selectable objects, moveable objects, and/or the like.

A virtual scene in a video game may refer to a specific section, area, or instance of the game world. It is a representation of the game world, focusing on a particular portion of a map for example. In an example, the virtual scene corresponds to the virtual environment at a portion of the map that is captured by a virtual camera and displayed to a user.

A virtual environment in a video game may refer to the entire game world or the interactive space where the gameplay takes place. In an example, the virtual environment corresponds to the entire map. The virtual environment may include interconnected digital spaces that encompass multiple virtual scenes, levels, or areas. For example, in a virtual environment, the focus is not only on the visual aspects but also on interactivity, usability, and/or the integration of various game mechanics, such as physics, artificial intelligence, and user input. The virtual environment can serve as the backdrop for gameplay and user interactions, to provide a cohesive and immersive experience.

The memory system 104 is any memory configured to store data. Some examples of the memory system 104 are storage devices, such as random-access memory (RAM) or read-only memory (ROM). The memory system 104 can include a RAM cache. In various aspects, data is stored within the memory system 104. The data within the memory system 104 may be cleared or ultimately transferred to the storage system 106.

The storage system 106 is any storage configured to retrieve and store data. Some examples of the storage system 106 are flash drives, hard drives, optical drives, and/or magnetic tape. In some aspects, the computing device 100 includes a memory system 104 in the form of RAM and a storage system 106 in the form of flash data. Both the memory system 104 and the storage system 106 include computer readable media which may store instructions or programs that are executable by a computer processor including the processor 102.

The communication network interface 108 can be coupled to a network (e.g., communication network) via a link 116. The communication network interface 108 may support communication over an Ethernet connection, a serial connection, a parallel connection, or an ATA connection, for example. The communication network interface 108 may also support wireless communication (e.g., 802.11 a/b/g/n, WiMax). It will be apparent to those skilled in the art that the communication network interface 108 can support any number of wired and wireless standards.

The I/O interface 110 is any device that receives input from the user and outputs data. The display interface 112 is any device that is configured to output graphics and data to a display. In one example, the display interface 112 is a graphics adapter.

It will be appreciated by those skilled in the art that the hardware elements of the computing device 100 are not limited to those depicted in FIG. 1. The computing device 100 may include more or less hardware elements than those depicted. Further, hardware elements may share functionality and still be within various aspects described herein.

Game map design is important to success in a competitive PVP game. When designing a competitive map for a PvP game, the game map may be symmetrical. Symmetry is important such that users do not begin the game with any inherent advantages by starting at a particular location of a game map. In addition, resources and non-gameplay obstacles may also be balanced to promote fair and balanced conditions for each user on the game map regardless of their starting position.

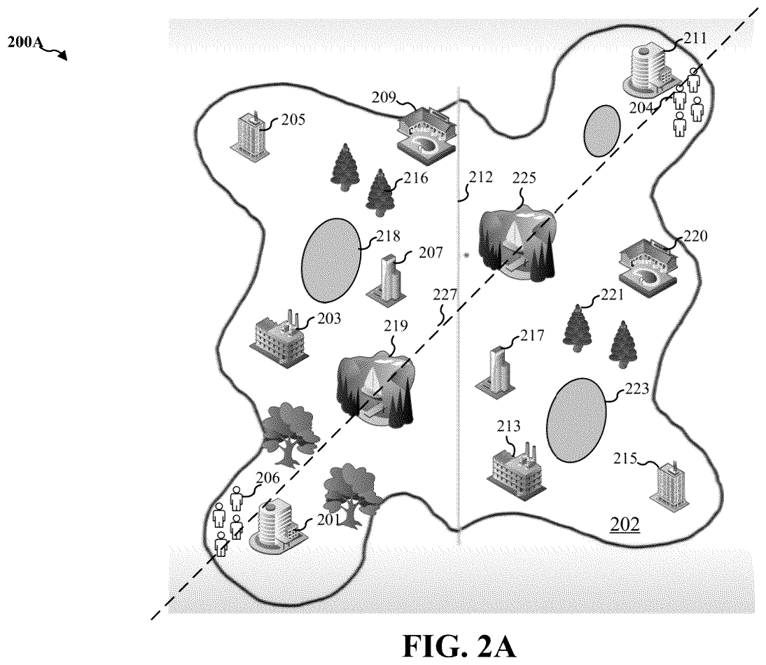

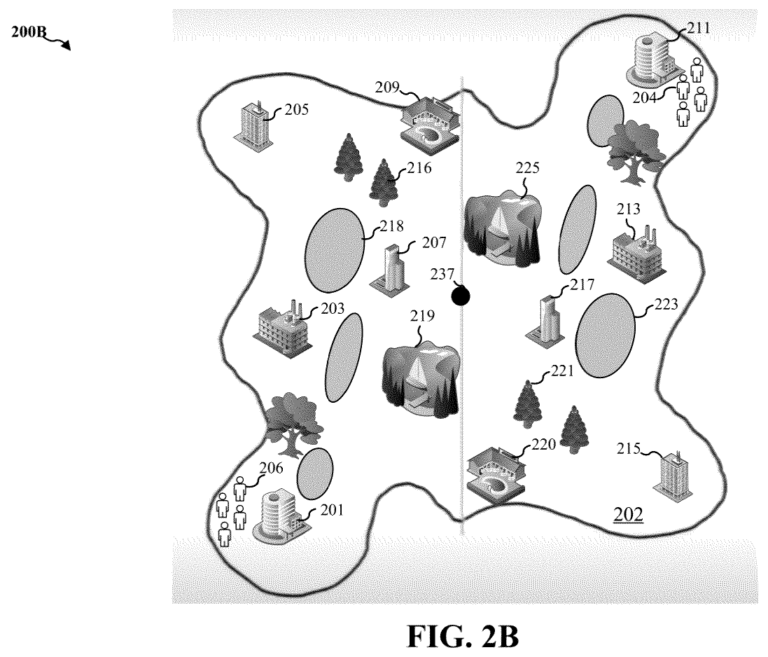

FIG. 2A is a diagram of an exemplary symmetrical game map according to an aspect of the present disclosure. While pertinent features are shown, those of ordinary skill in the art will appreciate from the present disclosure that various other features have not been illustrated for the sake of brevity and so as not to obscure more pertinent aspects of the example implementations disclosed herein.

As shown in example 200A of FIG. 2A, the game map 202 may be divided across a divisor line 212 separating a first user and second user such that a first user starts at a main base 201 (e.g., a bottom left side of the map) and a second user starts at a main base 211 (e.g., a top right side of the map). On the first user side (e.g., left side), the game map 202 may include impassible regions such as trees 216, mountains 218, and a lake 219. Game assets such as a virtual unit 206 and virtual objects such as the main base 201, a first expansion base 203, a second expansion base 205, a third expansion base 207, and a fourth expansion base 209 may be displayed on the map. Similarly, on the second user side (e.g., right side), the game map 202 includes impassible regions such as trees 221, mountains 223, and a lake 225. Game assets such as a virtual unit 204 and virtual objects such as the main base 211, a first expansion base 213, a second expansion base 215, a third expansion base 217, and fourth expansion base 220 may be displayed on the map.

As shown in FIG. 2A, to avoid one user having advantage over the other, the two user's bases, expansion bases, and non-game play element obstacles such as impassable regions (e.g., trees, lakes, mountains, rocks, fire, etc.) can be made to be symmetrical across an imaginary axis 227. Accordingly, for the first user, the action flows from bottom left to top right to engage the second user. Similarly, for the second user, the action flows from the top right to the bottom left to engage the first user.

In addition, when designing a competitive map, the designer of the map may set the resources (e.g., expansion bases) and general progression in a certain way that the users are encouraged to slowly advance towards each other. It is also important that these paths that the users are encouraged to take are diverse. In other words, there may be more than one way in which the users may be encouraged to take and engage in combat to keep the game interesting.

As can be seen in the game map 202, the resources of the game are disposed in such a way that the user is encouraged to consequently advance to the second and third expansion bases.

FIG. 2B is a diagram of another exemplary symmetrical game map according to an aspect of the present disclosure. While pertinent features are shown, those of ordinary skill in the art will appreciate from the present disclosure that various other features have not been illustrated for the sake of brevity and so as not to obscure more pertinent aspects of the example implementations disclosed herein.

As shown in example 200B from FIG. 2B, the two user bases, expansion bases, and impassable regions are symmetrical across a reference point 237 in the middle of the game map. Accordingly, for the first user, the action flows from bottom left to top right to engage the second user. Similarly, for the second user, the action flows from the top right to the bottom left to engage the first user.

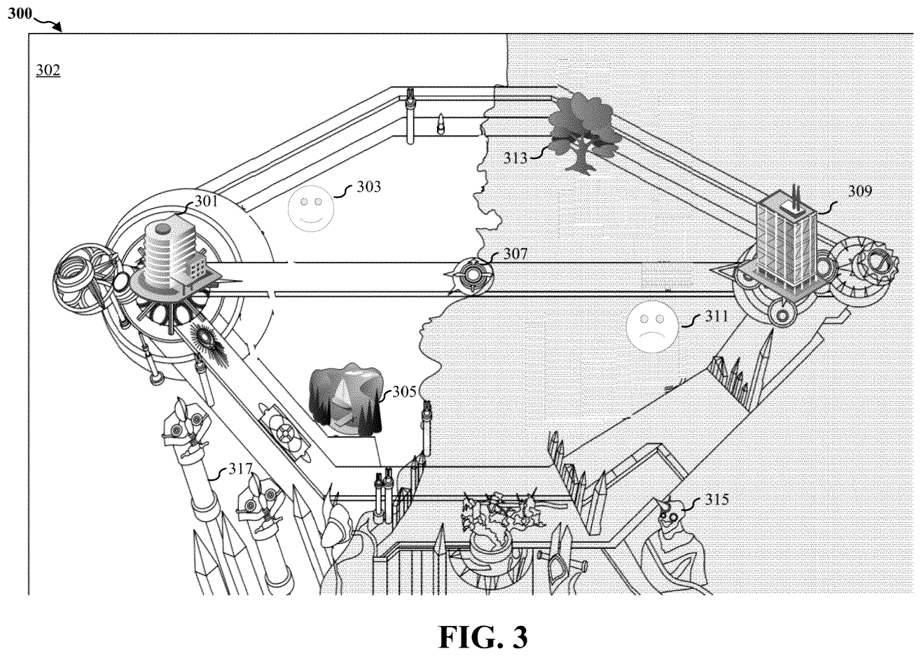

FIG. 3 is a diagram of another exemplary symmetrical game map according to aspects of the present disclosure. While pertinent features are shown, those of ordinary skill in the art will appreciate from the present disclosure that various other features have not been illustrated for the sake of brevity and so as not to obscure more pertinent aspects of the example implementations disclosed herein.

Similar to examples 200A-B from FIGS. 2A-B, example 300 of FIG. 3 shows a game map 302 that is balanced and appears symmetrical for both a first user and a second user. However, in contrast to FIGS. 2A-B, example 300 of FIG. 3 shows a map where the location of virtual objects are symmetrical, but may look different. For example, non-gameplay elements of a map such as texture or background do not necessarily need to be symmetrical or look the same in appearance. In addition, making these non-gameplay elements non-symmetrical makes the game map more interesting and less artificial. It should be noted that both the “player 1” side and the “player 2” side are symmetrical about a reference point 307.

As shown on the “player 1” side, the game map 302 contains a virtual object 301 (e.g., main base) and a virtual unit 303 controlled by a first player. Similarly, on the “player 2” side, the game map 302 contains a virtual object 309 (e.g., main base) and a virtual unit 311 controlled by a second player. As shown in example 300, the virtual objects 301, 309 and the virtual units 303 and 311 have different appearances, but have the same function and attributes.

As shown in example 300 of FIG. 3, the backgrounds for the two sides are not the same. For example, one side may be depicted as heaven as shown as being bright and one side may be depicted as hell as shown in a shadow. In addition, although the map's structure is generally the same, there may be differences in the terrain that vary from one part of the scenery to the other. For example, as shown in the bottom part of the screen, in the non-playable portions of the map, the “good” side features statues of guardians 317 whereas the “bad” side features a statue of a demon 315. In some examples, impassable regions are located at symmetrical positions of a map to block a same area of a navigation mesh, but may have different appearances. Specifically, in FIG. 3 the first impassable region 305 may be a lake and the second impassable region 313 may be a tree. Even though the first and second non-game play elements look different, they are located at symmetrical positions on the map such that they serve the same function of blocking a particular area of navigation mesh. It should be noted that even though the graphical representations of the certain elements (e.g., non-game play elements) do not appear the same on both sides, the paths, spacing, and other elements (e.g., ground truth gameplay elements) are symmetrical on both sides.

Example 300 illustrates that the displayed representation of non-game play elements does not necessarily have to be same since the users will not be able to traverse into that portion of the game map 302. For example, impassable regions such as the first impassable region 305 (e.g., the lake) and the second impassable region 313 (e.g., trees) within the game map 302 may be symmetrical, for example around the reference point 307. In some examples, virtual objects on non-playable areas of the game map 302 may also include different fixed virtual elements (e.g., statues of guardians 317 or statute of demon 315).

To put it another way, there may be a preference for each user to play from the perceived “good side” (e.g., heaven or player 1 side) and have their enemy play from the “bad side” (e.g., hell or player 2 side). Adjusting a perceived map location of one of the users will allow each of the users to appear to be playing from the “heaven” side and their enemy is always in “hell” in their own eyes. In addition, for their own game assets, their virtual object 301 (e.g., main base) may appear to be a happy castle and their virtual unit 303 may appear to be smiling whereas for their opponent's game assets, the opponent's virtual object 309 (e.g., main base) may look like a dark castle and the opponent's virtual unit 311 may appear to be frowning. In some examples, even the impassable regions on each side may look different. As an example, as shown in FIG. 3, on the “good side,” the first impassable region 305 is shown as a lake and. on the “bad side,” the second impassable region 313 is shown as a tree. However, in actuality, only one of the users is playing from the heaven side and the other user is playing from the hell side.

It should be noted that the appearance of virtual units, virtual objects, non-playable elements, and impassable regions can look vastly different as long as their footprints (e.g., occupying the same area) are the same.

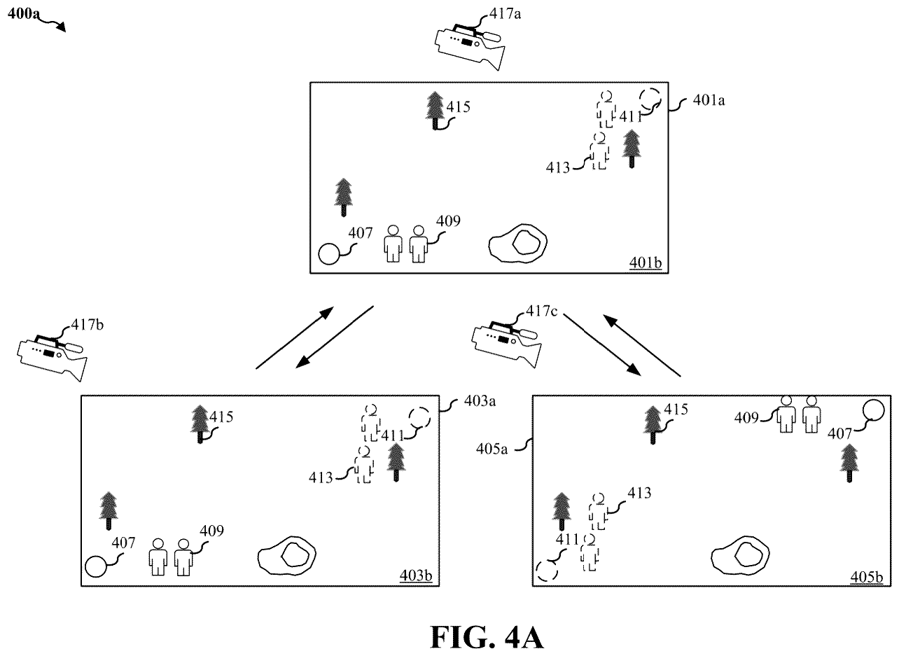

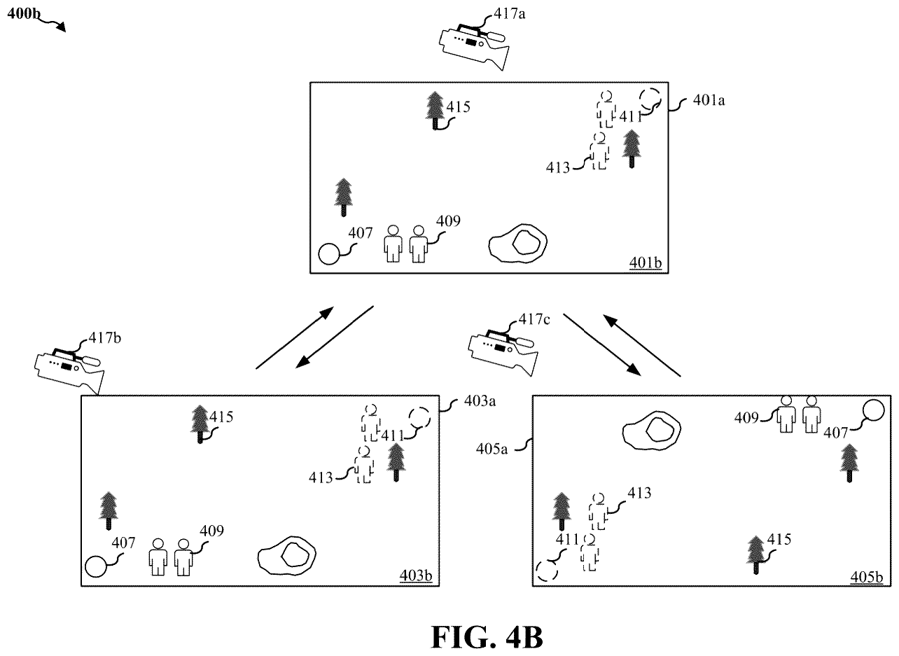

FIGS. 4A-4B are exemplary schematic diagrams showing a comparison of how a virtual environment could be rendered if no adjustment is performed versus if the adjustment is performed. While pertinent features are shown, those of ordinary skill in the art will appreciate from the present disclosure that various other features have not been illustrated for the sake of brevity and so as not to obscure more pertinent aspects of the example implementations disclosed herein.

Example 400a in FIG. 4A shows how the perceived map location for both users may be rendered if adjustment is performed. In an example, the adjustment is performed by adjusting the positions of the virtual units, virtual objects, and/or representations of impassable regions while the map stays fixed. The adjusting of the locations may be performed by rotating, or converting, coordinates of the game assets for a user playing in the flipped mode. Example 400b in FIG. 4B shows how the virtual environment for both users may be rendered if adjustment was performed by rotating or flipping the locations of the virtual units (e.g., virtual units controlled by both users), virtual objects, representations of the impassable regions, and the map.

A first user is playing in a “pass-through” mode since the perceived map location of the first user is the same as the actual, or ground truth, map location of the first user. A second user is playing in a flipped mode since the perceived map location of the second user is different from the actual, or ground truth, map location of the second user. However, as shown in computing device 405a for the second user, by adjusting a perceived map location of the second user in the game, a computing device of the second user will render and display graphics such that the second user will appear (e.g., from the perspective of the second user) to be playing from the bottom left corner on the computing device of the second user. This may remove any perceived imbalance or advantages of starting in the bottom left location (e.g., player 1 position).

Example 400a shows a ground truth (or ground point of truth) 401a, which contains the actual, or ground truth (e.g., real), positions of all the virtual game assets (e.g., virtual units and virtual objects) on the game map, computing device 403a shows the game map 403b as displayed to the first user, and computing device 405a shows the game map 405b as displayed to the second user after coordinates are adjusted according to the ground truth 401a. In some examples, the example 400a shows a virtual camera 417a shooting towards a camera angle for the first user that is determined to be playing in a flipped mode. The adjustment may be able to occur on one or more of the computing devices 403a, 405a or another computing device such as a server. The server may be utilized for online and/or cloud gaming for example.

As an example, the ground truth 401a may be thought of as chess notation since an entire game of chess may be played without actually rendering any visuals for each move. For example, using a chess analogy, a chess board is based on a system of coordinates (e.g., a-h for files, and 1-8 for ranks). To uniquely identify each square, each piece has its own letter abbreviation (e.g., “K” for King, “B” for Bishop, etc.) and each move in a game can be denoted as (and recorded) as chess notation. Accordingly, an entire game of chess can be played between users by simply using chess notation (e.g., without actually moving pieces on a chess board). Accordingly, if a player is playing as the black pieces and moves a King onto B6, the King is now on position B6 on the chess board for both the player playing the black pieces and the player playing the white pieces. This means that a video game may decide to graphically display this move (e.g., moving King to position B6) from a viewpoint of the “white” side different from the perspective of the “black” side. As an example, for the player playing the black pieces, the King may appear to move forward and, for the player playing the white pieces, the king may appear to move backward. However, this is just a matter of different viewpoints and the ground truth is still that the King is on position B6 of the chess board. In its simplest form, the ground truth 401a may show a move number, a name of the virtual unit that is moved, and then where the virtual unit has moved to.

In contrast to the present disclosure, a chess board does not have a board where an imaginary axis divides one side of the board such that one side of the board is white and one side of the board is black. In addition, the chess analogy is also different than the present disclosure because a chess board does not have non-game play elements that may block pathways.

The computing device 403a for the first user displays a game map 403b showing at least one non-playable element 415 (e.g., a tree), the virtual object 407 (e.g., main base) of the first user in the bottom left side of the game map 403b and at least one virtual unit 409 controlled by the first user, as depicted in solid lines, and the virtual object 411 for the second user in the top right side of the game map 403b and at least one virtual unit 413 controlled by the second user, depicted in dotted lines.

Since the first user is already playing in the bottom left location (e.g., player 1 position), there is no need to adjust coordinates for the virtual assets (e.g., virtual units and virtual objects) from the ground truth 401a and the first user plays in a “pass through” mode. The “pass through” mode means that the data from the ground truth 401a is passed through directly to be rendered by the computing device 403a. Accordingly, it should be noted that the computing device 403a displays a game map 403b that looks the same as the ground truth 401a. In some examples, the example 400a shows a virtual camera 417b shooting towards a camera angle for the first user that is determined to be playing in a normal mode (e.g., not flipped).

Since the second user is playing in the top right location (e.g., player 2 position or adjusted position), the present disclosure will adjust a perceived map location of the second user in the game by adjusting the locations of the virtual units 413, 409 and virtual objects 411, 407 such that the second user will perceive that they are playing from the bottom left location (e.g., player 1 position) and their opponent is in the top right location (e.g., player 2 position). In some examples, the example 400a shows a virtual camera 417c shooting towards a camera angle for the second user that is determined to be playing in a flipped mode. It should be noted that the game map is not adjusted as indicated by the non-playable elements 415 remaining in the same position in the game map 405b. Accordingly, when the ground truth 401a and the computing device 405a for the second user exchange data, the coordinates for the data may need to be adjusted back to the map location of the first player from the bottom left location in the game map 405b. Thus, as rendered and displayed to the second user, the computing device 405a will display a game map 405b that depicts the virtual object 411 (e.g., main base) of the second user as in the bottom left corner (e.g., player 1 position) and the virtual object 407 (e.g., main base) of the first user in the top right corner (e.g., player 2 position). In addition, the virtual unit 413 of the first user and the virtual unit 409 of the second user will also be displayed in a different map location than as shown in the ground truth 401a.

Thus, at the ground truth location of the virtual game assets (e.g., virtual units and virtual objects) as shown in example 400a, a first user (e.g., solid lines) begins in the virtual object 407 in the bottom left corner (e.g., player 1 position) and a second user (e.g., dotted lines) begins in the virtual object 411 (e.g., main base) in the top right corner of the map (e.g., player 2 position). However, by adjusting a map location of the second user, the second user will appear as though they are playing in the bottom left corner (e.g., player 1 position) location when an actual map location of the user is at the top right corner (e.g., player 2 position) location. Thus, in an example, the computing device 405a for the user playing in the flipped mode will decode the incoming command and location information to match their perceived map location.

Example 400b in FIG. 4B shows display locations of game elements for both users if adjustment is performed by rotating or flipping both the locations of game elements and representations of impassable regions and the map itself. Since the second user is playing in the top right location (e.g., player 2 position or rotated position), the present disclosure will adjust a map location of the second user in the game by adjusting the locations of the game elements (virtual units 413, 409 and virtual objects 411, 407 and non-playable elements 415 such that the second user will perceive that they are playing from the bottom left location (e.g., player 1 position) and their opponent is in the top right location (e.g., player 2 position). In some examples, the example 400b shows a virtual camera 417c shooting towards a camera angle for the second user that is determined to be playing in a flipped mode. Accordingly, when the ground truth 401a and the computing device 405a for the second user exchange data, the coordinates for the data will need to be adjusted back to the map location of the first player from the bottom left location in the game map 405b. Thus, as rendered and displayed to the second user, the computing device 405a will display a game map 405b that depicts the virtual object 411 of the second user as in the bottom left corner (e.g., player 1 position) and the virtual object 407 (e.g., main base) of the first user in the top right corner (e.g., player 2 position). In addition, the virtual unit 413 of the first user and the virtual unit 409 of the second user will also be displayed in a different map location than as shown in the ground truth 401a. However, this approach may require game developers and artists to draw particular virtual objects and map elements in the virtual environment from multiple angles since the virtual object could be approached from multiple directions and angles. In addition, referring back to FIG. 3, the player starting from the “bad” side (e.g., hell or player 2 side) will still see himself playing from the hell side since the map is adjusted with the locations of the virtual units.

Examples 400a-b from FIGS. 4A-4B shows that the present disclosure allows both users to play a same “side” by adjusting the map location of one of the users (e.g., the second user) to avoid the users from playing on top of each other on the game map.

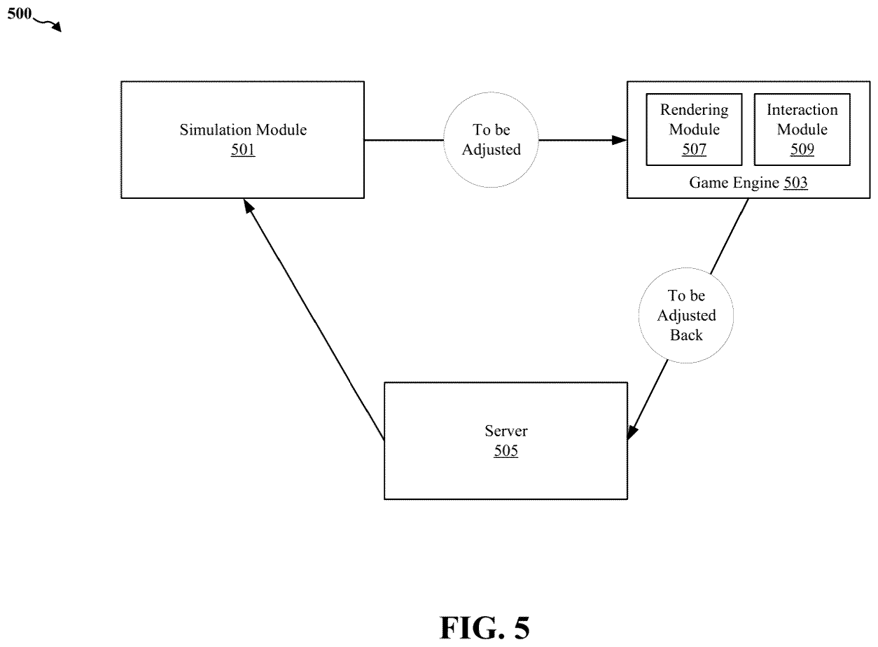

FIG. 5 is a schematic diagram of a game architecture according to aspects of the present disclosure. While pertinent features are shown, those of ordinary skill in the art will appreciate from the present disclosure that various other features have not been illustrated for the sake of brevity and so as not to obscure more pertinent aspects of the example implementations disclosed herein.

Example 500 includes a simulation module 501 (e.g., ground truth with ground truth positions), a game engine 503 for a flipped user, and a server 505. In some examples, the game engine 503 may include a rendering module 507 and an interaction module 509.

In some examples, the simulation module 501 may process a completely non-visual version of the game. The simulation module 501 maintains the reference positions for all virtual game assets (e.g., virtual units and virtual objects) in the virtual environment and the reference direction of inputs such that the simulation module 501 transmits the reference positions and inputs to all users. As will be explained in detail below, the positions are only adjusted if the receiving user is naturally in the “second player” position and playing in flipped mode. Referring back to the chess analogy, chess may be played purely in code or on a piece of paper and does not require a chess board. The chess board simply allows players to more easily see and keep track of their pieces and positions. The simulation module 501 is configured to transmit all of the positions of the virtual units, virtual objects, and representations of impassable regions in the game. In some examples, the simulation module 501 may be local to each user's computing device, but the simulation module 501 should be identical for all users. For example, a game asset layer which contains the ground truth positions of all game assets, such as virtual units and buildings will be the same for each player (e.g., not adjusted for the flipped player) and the map layer which contains positions of impassable areas and non-playable elements will be the same for all users. The simulation module 501 may be provided in one or more servers, for example in the case of a cloud game. In some examples, the simulation module 501 may include ground truth coordinates and positions of all virtual units, virtual objects (e.g., virtual buildings), and representations of impassable areas (e.g., trees, lakes, mountains, etc.). In some examples, the simulation module 501 may include a ground truth map of the virtual environment.

The game engine 503 may be specific to each user. In some examples, the game engine 503 is the Unity game engine. The respective game engines 503 each receive data from the simulation module 501 and update the visual renderings and representations of the virtual game assets (e.g., virtual units and virtual objects) in the game on the client of the user. One of the users will be designed as a flipped user such that the user will be in a flipped mode. Accordingly, when the rendering module 507 obtains data from the simulation module 501, the interaction module 509 will adjust the coordinates of the data to make it appear to the user playing in the flipped mode that they are in the “first player” position. In some examples, the data includes virtual game assets of both the first user and the second user. In addition, when the game engine 503 obtains input and commands from the user playing in the flipped mode, the interaction module 509 will also adjust the coordinates of the data from the inputs and commands before transmitting the input and commands to a server 505 for remaining users. For example, the user playing in the flipped mode may command a virtual unit to move left, but, in actuality, since the user is playing in the flipped mode, the virtual object actually moves to the right (e.g., the user playing in the flipped mode need not know which direction the virtual object is to move). As another example, the user playing in the flipped mode may command a virtual object to be built in a particular location on the device-displayed map, but in actuality, since the user is playing in the flipped mode, the virtual object should actually be built at another location on the ground truth map. In some examples, the interaction module 509 may adjust the coordinates of the data for things such as positions of a virtual unit and virtual object, rotations of the virtual unit and virtual object, aiming rotations of the virtual unit, and/or velocity of the virtual unit. Accordingly, when commands from the user playing in the flipped mode are sent to the simulation module 501, the commands may be adjusted back so the simulation module 501 always has the ground truth positions. In addition, the approach of determining whether to adjust coordinates for virtual units and virtual objects and actually adjusting the commands of users and positions of virtual units and virtual objects is executed at runtime so it requires no consideration from the art or simulation code.

In some examples, FlatBuffers is utilized as the data transport between the simulation module 501 to the game engine 503. FlatBuffers represent hierarchical data in a flat binary buffer in such a way that it may still be able to be accessed directly without parsing and/or unpacking.

In some examples, the server 505 is where all the commands by the users are obtained. Since the adjustment of any data is performed by the interaction module 509 on each respective client during data transfer, the server 505 does not need to track which user is flipped. The server 505 is configured to ensure that each user's command is replicated to the simulation module 501 of each user because the simulation module 501 has to be synchronized for both users. If the simulation modules goes out of sync, then there may be a de-sync error in the game.

In some examples, the approach of determining whether to adjust coordinates for virtual units and virtual objects and actually adjusting the commands of users and locations of the virtual units and virtual objects may be performed at the server when the server has knowledge of which user is playing in the flipped mode.

In some examples, Protocol Buffers (Protobuf) may be utilized as the data transport from the game engine 503 to the server 505. Protobuf provides a serialized format for packets of typed, structured data that are up to a few megabytes in size.

With the advancement of computer graphic and increased computing and processing power of computers, modern day games may now contain more detailed graphics that may be able to be rendered in 3-D to fully immerse users in the experience. When the game map contains virtual objects which may be approached from different angles and directions, artwork within the virtual environment needs to be designed and rendered from various angles and point of views (POVs) in order to appear real for all users. For example, a 3D-tree within the game map will need to be rendered from various sides, otherwise the virtual tree will not look good if a virtual camera associated with the user approaches the 3D-tree from an angle that is not rendered correctly. This may be extremely time consuming and computationally expensive to design, store, and render game maps.

The present disclosure provides another advantage in allowing game designers to take advantage of the symmetry of the game map and the fact that each player views fixed virtual objects in the virtual environment from a same perspective on their respective device displayed maps.

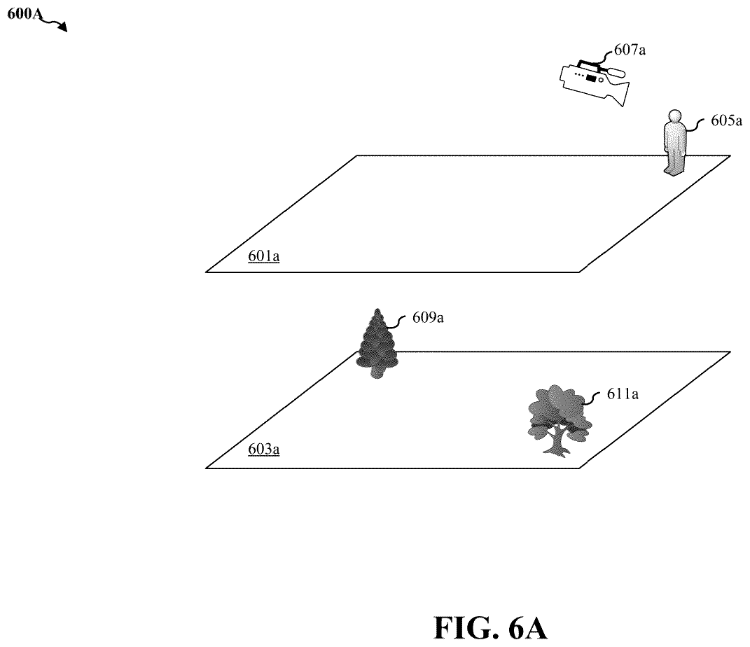

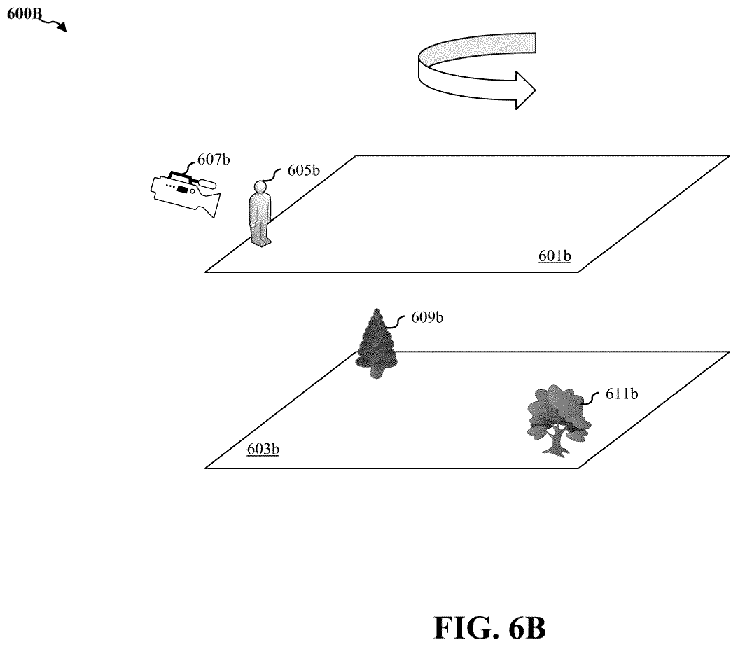

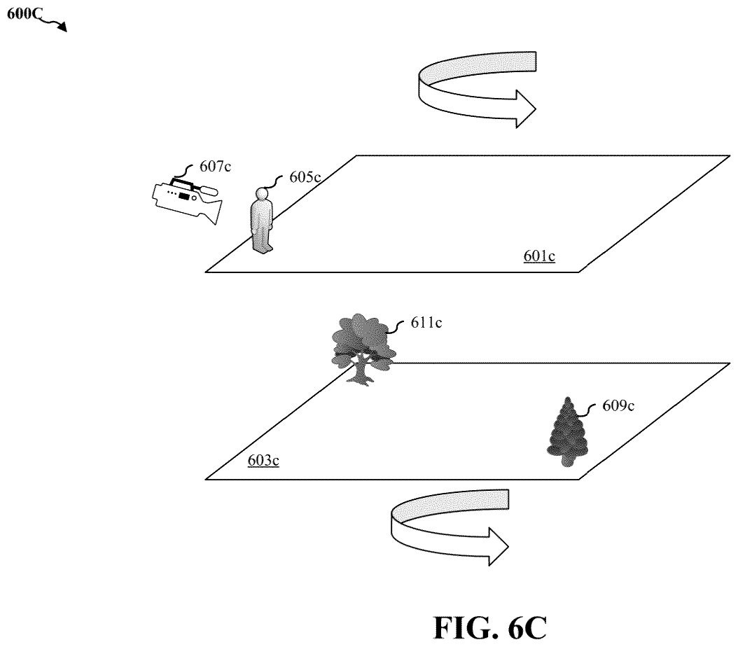

FIGS. 6A-6C illustrate schematic diagrams of adjusting a game asset layer on a fixed map layer according to some aspects of the present disclosure. The game asset layer includes a unit layer. While pertinent features are shown, those of ordinary skill in the art will appreciate from the present disclosure that various other features have not been illustrated for the sake of brevity and so as not to obscure more pertinent aspects of the example implementations disclosed herein. FIGS. 6A-6C depicts that a camera POV does not change for the player playing in the flipped mode (e.g., a same fixed camera angle perspective), but the map location of virtual units of the player is “flipped.”

As shown in example 600A of FIG. 6A, the positions of virtual units (e.g., virtual unit 605a controlled by a first user) controlled by all users may be tracked on a unit layer 601a and non-playable elements such as a representation of a first impassable region 609a (first type of tree) and a representation of a second impassable region 611a (second type of tree) may be tracked on a map layer 603a. In addition, the example 600A also shows a virtual camera 607a shooting towards a camera angle for the first user that is determined to be flipped. The unit layer 601b and the map layer 603b will be rendered such that the unit layer 601b is displayed on top of the map layer 603b.

As shown in example 600B of FIG. 6B, the positions of virtual units including the virtual unit 605b on a unit layer 601b is rotated 180 degrees around a reference point while the non-playable elements such as the representation of the first impassable region 609b and the representation of the second impassable region 611b stay fixed on the map layer 603b. It should be noted that even though the unit layer 601b has rotated, the virtual camera 607b still captures the same angle of the first user before (e.g., as depicted in FIG. 6A) and after the rotation (e.g., as depicted in FIG. 6B). In other words, the virtual camera 607b of the first user (e.g., user playing in the flipped mode) will show a same camera angle even after rotating the unit layer 601b. After the unit layer 601b has rotated then the unit layer 601b and the map layer 603b will be rendered such that the unit layer 601b is displayed on top of the map layer 603b.

As shown in example 600C of FIG. 6C, both the positions of virtual units including the virtual unit 605c on the unit layer 601c and the representation of the first impassable region 609c and the representation of a second impassable region 611c on the map layer 603c are rotated 180 degrees around a reference point. Again, it should be noted that even though the map layer 603c has rotated, the virtual camera 607c still captures a same angle of the first user before and after the rotation. After both the unit layer 601c and the map layer 603c are rotated, the unit layer 601c and the map layer 603b will be rendered such that the unit layer 601c is displayed on top of the map layer 603c.

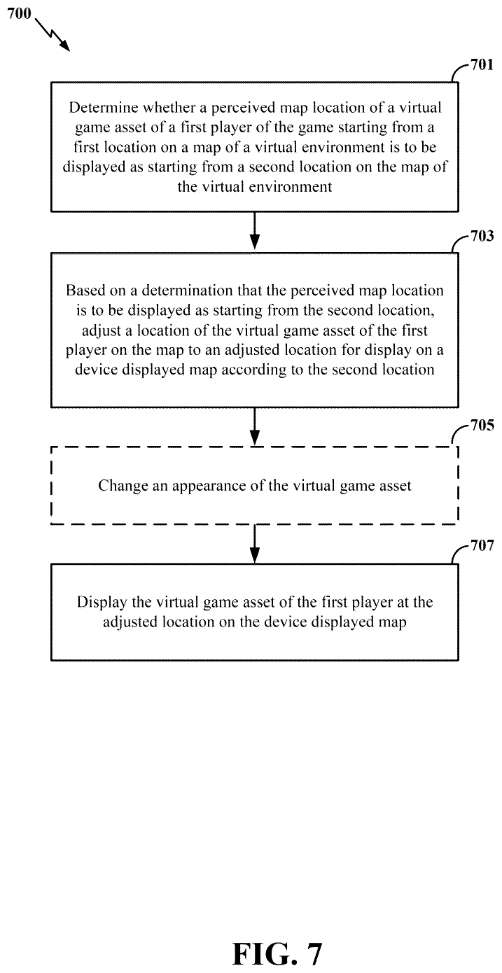

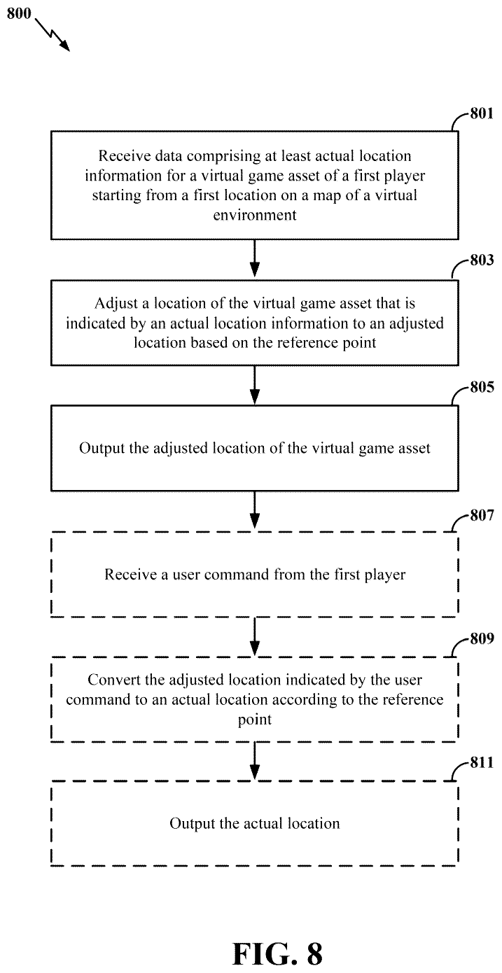

FIGS. 7 and 8 illustrate flowcharts of methods for adjusting a perceived map location of a first player (or user) in a game in accordance with one or more techniques of this disclosure.

In FIG. 7, the method 700 may be performed by an apparatus, such as the computing device 100, as described above. In some implementations, the method 700 is performed by processing logic (e.g., processing circuitry), including hardware, firmware, software, or a combination thereof. In some implementations, the method 700 is performed by a processor executing code stored in a non-transitory computer-readable storage medium (e.g., a memory). The method 700 includes adjusting a perceived map location of a first player in a video game at a computing device.

The method 700 may include setting the first player at a first location, or first main base, on a map of a virtual environment and a second player at a second location, or second main base, on the map of the virtual environment. The first location and the second location being symmetrical about a reference point on the map of the virtual environment. In some examples, the first location may be in a upper right region of the map and the second location may be in a lower left region of the map.

As an example, referring back to FIGS. 2A-2B, the first user may begin the game at a main base 211 in the upper right region of the game map 202 and the second user may begin the game at a main base 201 in the lower left region of the game map 202. Also, as shown in FIG. 2, the first initial location of the main base 211 and the second initial location of the main base 201 is symmetrical about a reference point on the game map 202 of the virtual environment.

As another example, referring back to FIG. 3, the first user may begin the game at a virtual object 309 (e.g., main base) on the right side of the game map 302 and the second user may begin the game at a virtual object 301 (e.g., main base) on the left side of the game map 302. Also, as shown in FIG. 3, the first initial location of the virtual object 309 is symmetrical around a reference point 307 on the game map 302 of the virtual environment.

As yet another example, referring back to FIG. 4A, the first user may begin the game at a virtual object 411 (e.g., main base) in the upper right region of the game map and the second user may begin the game at a virtual object 407 (e.g., main base) in the lower left region of the game map. Also, as shown in FIG. 4A, the first initial location of the virtual object 411 and the second initial location of the virtual object 407 is symmetrical around a reference point on the game map 401b of the virtual environment.

In some examples, the first player and the second player may each view fixed virtual game assets in the virtual environment from a same perspective on respective device displayed maps. The fixed virtual assets correspond to virtual objects. In other words, since the map is not rotated, each player will view the same elements in the map from a same angle. This allows game designers to author art for both users with a single perspective since each user views fixed virtual game assets (e.g., buildings) or impassable regions such as mountains or trees in the virtual environment from a same perspective. In this way, the game designers may simplify the environmental art creation process by better optimizing visuals from a single point of view (e.g., focusing detail on one side of a tree and not worrying about the “back side” of a tree, which will not be seen by a camera angle). The reduced artwork also allows a reduction in processing and/or data needed to render the artwork for display,

In some examples, the map may include X, Y, and Z coordinates. A virtual camera may display the virtual scene from a fixed isometric camera angle (e.g., approximately a 30-45 degree angle). In some examples, the map of the virtual environment may include radial symmetry around the reference point.

In some examples, the game map may include impassable regions that are symmetrical around the reference point. As an example, referring back to FIG. 2B, the game map 202 contains impassable regions such as mountains 218, 223 and lakes 219, 225 that are symmetrical around the reference point 237. As another example, referring back to FIG. 3, the game map 302 contains impassable regions such as a first impassable region 305 and a second impassable region 313 that are symmetrical around the reference point 307.

In some examples, a first impassable region and a second impassable region on opposite sides of the reference point may include different fixed virtual elements. As an example, referring back to FIG. 3, the first impassable region may contain statues of guardians 317 and the second impassable region may contain a statue of a demon 315, which are different fixed virtual elements on opposite sides of a reference point 307. As another example, referring back to FIG. 3, the game map 302 contains different impassable regions such as a first impassable region 305 (e.g., lake) and the second impassable region 313 (e.g., trees), which are different fixed virtual elements on opposite sides of the reference point 307.

At block 701, the method 700 may include determining whether the perceived map location of a virtual game asset (virtual object or virtual unit) of a first player starting from a first location on a map of a virtual environment is to be displayed as starting from a second location on the map of the virtual environment. The first location and the second location may be symmetrical about a reference point on the map of the virtual environment. As an example, referring to FIG. 4A, a second user on the second computing device 405a that begins at the virtual object 411 (e.g., main base) is determined to be playing in an adjusted map location such that the second user appears to begin from the second location (e.g., a first map location of the second user is adjusted to a second map location of the first user that begins at the virtual object 407, or main base, on the game map 401b of the virtual environment) and virtual units 413 controlled by the second user and the virtual units 409 controlled by the first user are also adjusted from the perspective of the second user. The adjustment may be provided as an option to the user or performed automatically.

At block 703, the method 700 may include, based on a determination that the perceived map location is to be displayed from the second location, adjusting a location of the virtual game asset of the first player on the map to an adjusted location for display on a device displayed map according to the second location. As an example, referring back to FIG. 4A, as compared to the ground truth 401a, ground truth positions of a virtual units 409 and 413 and even virtual objects 407, 411 such as main bases are converted to an adjusted location on the computing device 405a. As another example, referring back to FIG. 6B, the unit layer 601b containing positions of all virtual units or virtual buildings belonging to all players is also adjusted while the map layer 603b containing positions for all fixed virtual objects or impassable regions remains fixed.

At block 705, the method 700 may include, based on a determination that the perceived map location is to be displayed as starting from the second location, changing an appearance of the virtual game asset. For example, as shown in FIG. 3, adjusting (e.g., rotating or flipping) a map location of one of the users will allow each users to appear to be playing from the “heaven” side and their enemy is always in “hell” in their own eyes. Specifically, for their own game assets and from their own perspective, their virtual object 301 may appear to be a happy castle and their virtual unit 303 may appear to look like angel soldiers whereas, for game assets belonging to their opponents and only from their own perspective, the virtual object 309 of their opponent may look like a dark castle and virtual unit 311 of their opponent may appear to look like demon soldiers.

At block 707, the method 700 may include displaying the virtual game asset of the first player at the adjusted location on the device displayed map. The displayed adjusted location may be different from an actual location of the virtual object on the map in the virtual environment. As an example, referring back to FIG. 4A, as compared to the ground truth 401a, ground truth positions of a virtual game asset such as a virtual units 409 and 413 and even virtual objects 407, 411 are rendered and displays as adjusted positions on the device displayed game map 405b on the computing device 405a. As another example, referring back to FIGS. 6A-6B, the unit layer 601a, 601b is adjusted while the map layer 603a, 603b is fixed such that the location of the virtual units 605a, 605b is different in example 600A and example 600B.

In some examples, the game may be a competitive strategy game. For example, the game may be a RTS game, a FPS game, or a MOBA game as long as the game is being played in a virtual game environment where the game map, interactive objects, and obstacles are all symmetrical (e.g., has radial symmetry) along a reference point and all moving objects and commands from all players travel through a data layer to reach a server or component that devices the final location of the object.

It is understood that the method illustrated by FIG. 7 is exemplary in nature and that the steps described herein may be combined or modified to generate alternative aspects.

In FIG. 8, the method 800 may be performed by an apparatus, such as the computing device 100, as described above. In some implementations, the method 800 is performed by processing logic (e.g., processing circuitry), including hardware, firmware, software, or a combination thereof. In some implementations, the method 800 is performed by a processor executing code stored in a non-transitory computer-readable storage medium (e.g., a memory). The method 800 includes adjusting a perceived map location of a first player in a video game at a computing device. Optional aspects are illustrated in dashed lines.

At block 801, the method 800 may include receiving data comprising at least actual location information for a virtual object of a first player starting from a first location on a map of a virtual environment. A perceived map location of the virtual object of the first player may be adjusted to a second location on the map of the virtual environment. The first location and the second location may be symmetrical about a reference point on the map of the virtual environment. The first location and the second location may be symmetrical about a reference point on the map of the virtual environment. In some examples, the first location may be in an upper right region of the map and the second location may be in a lower left region of the map.

In some examples, a POV of the first player may be captured by a virtual camera positioned above the virtual environment and a perspective of the second player may be captured by another virtual camera positioned above the virtual environment. The virtual cameras for both of the players may point towards a same camera angle on the map, but, in some cases, the virtual cameras may zoom in and pan around the map. As an example, referring back to FIG. 6A-6C, the virtual camera 607a-c may have a fixed camera angle and will point towards a same camera angle on the map, which may result in the fixed camera angle being an approximately 30-45 degree, isometric camera angle.

In some examples, the data further may include at least one of movement information, rotation information, aiming rotation information, or velocity information for the virtual game asset. The virtual game asset includes a virtual unit.

In some examples, the first player and the second player may each view fixed virtual game assets in the virtual environment from a same camera POV on respective device displayed maps. The fixed virtual game assets include virtual objects. Since the virtual cameras for both of the first player and the second player will point towards a same camera angle on the map, game developers and artists will only need to draw particular virtual game assets and map elements in the virtual environment from certain angles and not from all angles since the virtual object will not be approached from that angle (e.g., such as the backside of a tree).

In some examples, the map may include X, Y, and Z coordinates. In some examples, the map of the virtual environment may include radial symmetry around the reference point.

In some examples, the map may include impassable regions that are symmetrical around the reference point. As an example, referring back to FIG. 3, the impassable regions 305 and 313 are impassable objects that are symmetrical around the reference point 307.

At block 803, the method 800 may include adjusting a location of the virtual game asset that is indicated by the actual location information to an adjusted location based on the reference point. As an example, referring back to FIG. 4A, when the ground truth 401a and the computing device 405a for the second user exchange data, the adjusted coordinates for the data and positions will be converted to a ground truth position according to a reference point. As another example, referring back to FIG. 6B, the unit layer 601b containing locations of all virtual game assets (e.g., virtual units and/or virtual buildings) controlled by all users will be adjusted and the game map containing locations of impassable regions will be fixed.

Further, as an example of rotating around a reference point, assuming a 2-D map, if a reference point has coordinates (2,2) and a unit position is (3,3), then after performing a 180 clockwise (or counter clockwise) rotation, the unit position is now on (1,1). As an example of rotating around an axis, if the map is rotated around the Y axis and the unit position is (3,3), then after performing a 180 clockwise (or counter clockwise) rotation, the unit position is now on (−3,3). As an example, referring back to FIG. 2B, the two user bases, expansion bases, and impassable regions are symmetrical across a reference point 237, which is also directly in the middle of the game map.

In some examples, adjusting the location may include reflecting coordinates of the data over an X-axis and Z-axis of the map. In some examples, the adjusting the location of the virtual game asset that is indicated by the location information to the adjusted location results in the virtual game asset of the first player being displayed at the adjust location that is rotated 180 degrees around the reference point of the map.

At block 805, the method 800 may include outputting the adjusted location of the virtual game asset. The adjusted location may be different from the location indicated by the actual location information for the virtual game asset of the first player on the map in the virtual environment. As an example, referring back to FIGS. 6A-6B, the unit layer 601a, 601b has adjusted while the map layer 603a, 603b is fixed such that the location of the virtual units 605a, 605b is different in example 600A and example 600B.

As an example, referring back to FIG. 4A, as rendered and displayed to the second user, the computing device 405a will display a game map 405b that depicts the virtual object 411 (or starting location) of the second user as in the bottom left corner (e.g., player 1 position) and the virtual object 407 (or starting location) of the first user in the top right corner (e.g., player 2 position). In addition, in FIG. 4A, the virtual unit 413 of the first user and the virtual unit 409 of the second user will also be displayed in a different map location than as shown in the ground truth 401a.

At block 807, the method 800 may include receiving a user command from the first player. The user command may indicate an adjusted location on the map. In some examples, the user command may include any commands regarding a virtual game asset such as generating a virtual unit or virtual object, commanding a virtual unit to move, commanding a virtual unit to attack, commanding a virtual unit to defend, or the like.

At block 809, the method 800 may include converting the adjusted location indicated by the user command to an actual location according to the reference point.

In some examples, converting the adjusted location may include reflecting coordinates of the data from the user command over an X-axis and Z-axis of the map.

At block 811, the method 800 may include outputting the actual location. The actual location may be different from the adjusted location for the virtual game asset of the first player in the virtual environment. In some examples, the actual location of the virtual game asset may be outputted to a server or some other component that decides a final location of a virtual game asset before transmitting the data regarding to the final location of the virtual object to clients.

It is understood that the method illustrated by FIG. 8 is exemplary in nature and that the steps described herein may be combined or modified to generate alternative aspects.

Although the present disclosure is explained in the context of a competitive strategy game, such as an RTS game, the subject matter described herein may be implemented across any virtual environment where a game map and certain fixed objects in the map are symmetrical along a single point of rotation. Moving objects and commands from users may travel through a data layer to reach a server that decides a final location of the object for all users or the final positions may be determined by one or more computing devices in some aspects.

The subject matter described herein can be implemented to realize one or more benefits. For instance, the techniques disclosed herein enable a method of reducing any “perspective” advantage in starting positions on a symmetrical game map. In other words, the techniques provide each user a same perceived map location regardless of a user's initial location on the map and what direction a player is playing in. For example, this allows both users to see their actions coming from a “default” game flow of bottom left to face their opponents in the top right. In addition, since all users each view virtual objects in the virtual environment from a same camera POV, art in the virtual environment does not need to be modeled from all sides and angles. This may greatly reduce the file size of game maps and facilitate quicker loading times for users when playing a video game.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing unit may be implemented in hardware (e.g., by processing circuitry), software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware.

What is claimed is:

1. A method of adjusting a perceived map location in a game, the method comprising:
determining whether the perceived map location of a virtual game asset of a first player of the game starting from a first location on a map of a virtual environment is to be displayed as starting from a second location on the map of the virtual environment, the first location and the second location being symmetrical about a reference point on the map of the virtual environment;
based on a determination that the perceived map location is to be displayed as starting from the second location, adjusting a location of the virtual game asset of the first player on the map to an adjusted location for display on a device displayed map according to the second location; and
displaying the virtual game asset of the first player at the adjusted location on the device displayed map, the adjusted location being different from an actual location of the virtual game asset on the map in the virtual environment.

2. The method according to claim 1, wherein the map of the virtual environment comprises radial symmetry around the reference point.

3. The method according to claim 1, wherein the map comprises impassable regions that are symmetrical around the reference point.

4. The method according to claim 1, wherein a first impassable region and a second impassable region on opposite sides of the reference point include different fixed virtual elements.

5. The method according to claim 1, wherein
the first location is in a upper right region of the map, and
the second location is in a lower left region of the map.

6. The method according to claim 1, wherein the first player and a second player each view fixed virtual game assets in the virtual environment from a same direction on respective device displayed maps, wherein the fixed virtual game assets include virtual objects.

7. The method according to claim 1, further comprising:
based on a determination that the perceived map location is to be displayed as starting from the second location, changing an appearance of the virtual game asset.

8. A method of adjusting a perceived map location in a game, the method comprising:
receiving data comprising at least actual location information for a virtual game asset of a first player starting from a first location on a map of a virtual environment, the perceived map location of the virtual game asset of the first player being adjusted to a second location on the map of the virtual environment, the first location and the second location being symmetrical about a reference point on the map of the virtual environment;
adjusting a location of the virtual game asset that is indicated by an actual location information to an adjusted location based on the reference point; and
outputting the adjusted location of the virtual game asset, the adjusted location being different from the location indicated by the actual location information for the virtual game asset of the first player on the map in the virtual environment.

9. The method according to claim 8, wherein the map comprises X, Y, and Z coordinates, and the adjusting the location comprises:
reflecting coordinates of the data over an X-axis and Z-axis of the map.

10. The method according to claim 8, wherein the map of the virtual environment comprises radial symmetry around the reference point.

11. The method according to claim 8, wherein the map comprises impassable regions that are symmetrical around the reference point.

12. The method according to claim 8, wherein
the first location is in a upper right region of the map, and
the second location is in a lower left region of the map.

13. The method according to claim 8, wherein the first player and a second player each view fixed virtual game assets in the virtual environment from a same camera point of view (POV) on respective device displayed maps, wherein the fixed virtual game assets include virtual objects.

14. The method according to claim 8, wherein the data further comprises at least one of movement information, rotation information, aiming rotation information, or velocity information for the virtual game asset, wherein the virtual game asset includes a virtual unit.

15. The method according to claim 8, wherein the adjusting the location of the virtual game asset that is indicated by the location information to the adjusted location results in the virtual game asset of the first player being displayed at the adjusted location that is rotated 180 degrees around the reference point of the map.

16. The method according to claim 8, further comprising:
receiving a user command from the first player, the user command indicating an adjusted location on the map;
converting the adjusted location indicated by the user command to an actual location according to the reference point; and
outputting the actual location, the actual location being different from the adjusted location for the virtual game asset of the first player on the map in the virtual environment.

17. The method according to claim 16, wherein the map comprises X, Y, and Z coordinates; and converting the adjusted location comprises:
reflecting coordinates of the data from the user command over an X-axis and Z-axis of the map.

18. An apparatus for adjusting a perceived map location in a game, the apparatus comprising:
processing circuitry configured to:
determine whether the perceived map location of a virtual game asset of a first player of the game starting from a first location on a map of a virtual environment is to be displayed as starting from a second location on the map of the virtual environment, the first location and the second location being symmetrical about a reference point on the map of the virtual environment;
based on a determination that the perceived map location is to be displayed as starting from the second location, adjust a location of the virtual game asset of the first player on the map to an adjusted location for display on a device displayed map according to the second location; and
display the virtual game asset of the first player at the adjusted location on the device displayed map, the adjusted location being different from an actual location of the virtual game asset on the map in the virtual environment.

19. The apparatus according to claim 18, wherein the map of the virtual environment comprises radial symmetry around the reference point.

20. The apparatus according to claim 18, wherein the map comprises impassable regions that are symmetrical around the reference point.

21. The apparatus according to claim 18, wherein a first impassable region and a second impassable region on opposite sides of the reference point include different fixed virtual elements.

22. The apparatus according to claim 18, wherein
the first location is in a upper right region of the map, and
the second location is in a lower left region of the map.

23. The apparatus according to claim 18, wherein the first player and a second player each view fixed virtual game assets in the virtual environment from a same direction on respective device displayed maps, wherein the fixed virtual game assets includes virtual objects.

24. The apparatus according to claim 18, wherein the processing circuitry is further configured to:
based on a determination that the perceived map location is to be displayed as starting from the second location, change an appearance of the virtual game asset.

25. An apparatus for adjusting a perceived map location in a game, the apparatus comprising:
processing circuitry configured to:
receive data comprising at least actual location information for a virtual game asset of a first player starting from a first location on a map of a virtual environment, the perceived map location of the virtual game asset of a first player being adjusted to a second location on the map of the virtual environment, the first location and the second location being symmetrical about a reference point on the map of the virtual environment;
adjust a location of the virtual game asset that is indicated by an actual location information to an adjusted location based on the reference point; and
output the adjusted location of the virtual game asset, the adjusted location being different from the location indicated by the actual location information for the virtual game asset of the first player on the map in the virtual environment.

26. The apparatus according to claim 25, wherein the map comprises X, Y, and Z coordinates; and the adjusting the location comprises:
reflecting coordinates of the data over an X-axis and Z-axis of the map.

27. The apparatus according to claim 25, wherein the map of the virtual environment comprises radial symmetry around the reference point.

28. The apparatus according to claim 25, wherein the map comprises impassable regions that are symmetrical around the reference point.

29. The apparatus according to claim 25, wherein
the first location is in a upper right region of the map, and
the second location is in a lower left region of the map.

30. The apparatus according to claim 25, wherein the first player and a second player each view fixed virtual objects in the virtual environment from a same camera point of view (POV) on respective device displayed maps, wherein the fixed virtual objects include virtual objects.

31. The apparatus according to claim 25, wherein the data further comprises at least one of movement information, rotation information, aiming rotation information, or velocity information for the virtual game asset, wherein the virtual game asset include a virtual unit.

32. The apparatus according to claim 25, wherein the adjusting the location of the virtual game asset that is indicated by the location information to the adjusted location results in the virtual game asset of the first player being displayed at the adjust location that is rotated 180 degrees around the reference point of the map.

33. The apparatus according to claim 25, wherein processing circuitry is further configured to:
receive a user command from the first player, the user command indicating an adjusted location on the map;
convert the adjusted location indicated by the user command to an actual location according to the reference point; and
output the actual location, the actual location being different from the adjusted location for the virtual game asset of the first player on the map in the virtual environment.

34. The apparatus according to claim 33, wherein the map comprises X, Y, and Z coordinates; and the converting the adjusted location comprises:
reflecting coordinates of the data from the user command over an X-axis and Z-axis of the map.

35. A non-transitory computer-readable storage medium storing computer-readable instructions thereon, which, when executed by processing circuitry, cause the processing circuitry to perform a method of adjusting a perceived map location in a game, the method comprising:
determining whether the perceived map location of a virtual game asset of a first player of the game starting from a first location on a map of a virtual environment is to be displayed as starting from a second location on the map of the virtual environment, the first location and the second location being symmetrical about a reference point on the map of the virtual environment;
based on a determination that the perceived map location is to be displayed as starting from the second location, adjusting a location of the virtual game asset of the first player on the map to an adjusted location for display on a device displayed map according to the second location; and
displaying the virtual game asset of the first player at the adjusted location on the device displayed map, the adjusted location being different from an actual location of the virtual game asset on the map in the virtual environment.

36. The non-transitory computer-readable storage medium according to claim 35, wherein the map of the virtual environment comprises radial symmetry around the reference point.

37. The non-transitory computer-readable storage medium according to claim 35, wherein the map comprises impassable regions that are symmetrical around the reference point.

38. The non-transitory computer-readable storage medium according to claim 35, wherein a first impassable region and a second impassable region on opposite sides of the reference point include different fixed virtual elements.

39. The non-transitory computer-readable storage medium according to claim 35, wherein
the first location is in a upper right region of the map, and
the second location is in a lower left region of the map.

40. The non-transitory computer-readable storage medium according to claim 35, wherein the first player and a second player each view fixed virtual game assets in the virtual environment from a same direction on respective device displayed maps, wherein the fixed virtual game assets include virtual objects.

41. The non-transitory computer-readable storage medium according to claim 35, the method further comprising:
based on a determination that the perceived map location is to be displayed as starting from the second location, changing an appearance of the virtual game asset.

42. A non-transitory computer-readable storage medium storing computer-readable instructions thereon, which, when executed by processing circuitry, cause the processing circuitry to perform a method of adjusting a perceived map location in a game, the method comprising:
receiving data comprising at least actual location information for a virtual game asset of a first player starting from a first location on a map of a virtual environment, the perceived map location of the virtual game asset of a first player being adjusted to a second location on the map of the virtual environment, the first location and the second location being symmetrical about a reference point on the map of the virtual environment;
adjusting a location of the virtual game asset that is indicated by an actual location information to an adjusted location based on the reference point; and
outputting the adjusted location of the virtual game asset, the adjusted location being different from the location indicated by the actual location information for the virtual game asset of the first player on the map in the virtual environment.

43. The non-transitory computer-readable storage medium according to claim 42, wherein the adjusting the location comprises:
reflecting coordinates of the data over an X-axis and Z-axis of the map.

44. The non-transitory computer-readable storage medium according to claim 42, wherein the map of the virtual environment comprises radial symmetry around the reference point.

45. The non-transitory computer-readable storage medium according to claim 42, wherein the map comprises impassable regions that are symmetrical around the reference point.

46. The non-transitory computer-readable storage medium according to claim 42, wherein
the first location is in a upper right region of the map, and
the second location is in a lower left region of the map.

47. The non-transitory computer-readable storage medium according to claim 42, wherein the first player and a second player each view fixed virtual game assets in the virtual environment from a same camera point of view (POV) on respective device displayed maps, wherein the fixed virtual game assets include virtual objects.

48. The non-transitory computer-readable storage medium according to claim 42, wherein the data further comprises at least one of movement information, rotation information, aiming rotation information, or velocity information for the virtual game asset, wherein the virtual game asset includes a virtual unit.

49. The non-transitory computer-readable storage medium according to claim 42, wherein the adjusting the location of the virtual game asset that is indicated by the location information to the adjusted location results in the virtual game asset of the first player being displayed at the adjust location that is rotated 180 degrees around the reference point of the map.

50. The non-transitory computer-readable storage medium according to claim 42, wherein the method further comprises:
receiving a user command from the first player, the user command indicating an adjusted location on the map;
converting the adjusted location indicated by the user command to an actual location according to the reference point; and
outputting the actual location, the actual location being different from the adjusted location for the virtual game asset of the first player on the map in the virtual environment.

51. The non-transitory computer-readable storage medium according to claim 50, wherein the converting the adjusted location comprises:
reflecting coordinates of the data from the user command over an X-axis and Z-axis of the map.
